(19) United States
(12) Patent Application Publication
(10) Pub. No.: US 2010/0102835 A1
(43) Pub. Date: Apr. 29, 2010

(54) METHOD AND SYSTEM FOR DETECTING A CORROSIVE DEPOSIT IN A COMPRESSOR

(75) Inventors: Rahul J. Chillar, Marietta, GA (US); Stephen D. Hiner, Salisbury (GB); Aaron M. Smith, Smyrna, GA (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/258,695

(22) Filed: Oct. 27, 2008

(51) Int. Cl. G01N 17/02

(52) U.S. Cl. 324/700

(57) ABSTRACT

An embodiment of the present invention may analyze, in or near real time, a sample of effluent exiting a compressor after an offline water-wash cycle. The results of the analysis may determine the level of fouling or level of corrosive deposits on the compressor. An embodiment of the present invention may allow for a control system to receive the analysis and determine whether an additional offline water-wash cycle should be performed to reduce the level of fouling or level of at least one corrosive deposits. An embodiment of the present invention may link the control system with a remote monitoring and diagnostics center for further review of the effluent and the compressor fouling. An embodiment of the present invention may link to a mitigation process, such as, but not limiting of, an on-line water wash system, if required.

### BACKGROUND OF THE INVENTION

The present invention relates generally to a turbomachine; and more particularly to a method for automatically determining the level of fouling and the constituent elements that may cause fouling, within a compressor of a turbomachine.

Some turbomachines, such as, but not limiting of, gas turbines, and aero-derivatives, have an air inlet system that channels the incoming airstream towards a compressor. The air inlet system usually has a filter section, which screens the airstream of foreign objects and other undesired materials. Typically, the air inlet system and the compressor are created out of metals that may corrode due to the environment (ambient conditions, etc) in which the turbomachine operates. These turbomachines may develop microenvironments related to the ambient conditions in which the turbomachine operates. These microenvironments, which have accelerated airflows and pressures, typically increase the corrosion rate of the compressor.

Fouling is considered a build up of material on components of the compressor, such as, but not limiting of, compressor blades. Fouling leads to a modified aerodynamic profile, which reduces the efficiency of the compressor. The fouling and corrosion of the compressor can significantly impact the performance and heat-rate of the turbomachine. Therefore, the sooner an operator of the turbomachine learns of compressor fouling and corrosion; the sooner mitigation efforts can start. A commonly used nitigation effort involves using a water-wash system.

Water-wash systems are commonly used to remove contaminants and to reduce the corrosives on the compressor of the turbomachines. Some water-wash systems operate while the turbomachine is no longer producing power. These are commonly referred to as “offline” water-wash systems. Off-line water-wash systems typically use de-mineralized water (hereinafter “de-min water”) and a detergent to clean the compressor. Offline water-wash creates an effluent that drains out of the compressor. The effluent comprises the de-min water, detergent, fouling materials and corrosives elements that were on components of the compressor.

The contents of the effluent may be analyzed to determine the severity of compressor fouling and corrosiveness. The effluent can be used to determine how long to operate the offline water-wash system in order to clean compressor.

Some known systems require that a sample of the effluent be sent offsite to determine the level and types of contaminants and corrosives on the compressor. These systems delay the start of mitigation efforts such as operating an on-line water system, or the like. Generally, on-line water washing may be considered the process of injecting a cleaning fluid such as, but not limiting of, de-min water, into the inlet of the compressor while the turbomachine operates near a synchronous speed. On-line water washing provides the advantage of cleaning the compressor without shutting down the turbomachine.

For the foregoing reasons, there is a need for a method that analyzes, in real-time, the effluent generated during an offline water-wash. The method should determine the severity of fouling and corrosiveness within the compressor. The method should link the analysis of the effluent with mitigation effort. The method should also link with a remote system, or the like.

### BRIEF DESCRIPTION OF THE INVENTION

In an embodiment of the present invention, a method of detecting at least one contaminant on a component of a compressor, the method comprising: providing an offline water-wash system comprising a drainage system; wherein the offline water-wash system performs the steps of: injecting a cleaning fluid into a compressor of a turbomachine; and utilizing the drainage system to receive an effluent created by the offline water-wash system; wherein the effluent comprises the cleaning fluid; utilizing a device to analyze the effluent, wherein the device generates data on a present analysis of the effluent; and providing a control system, wherein the control system performs at least one of the following the steps of: receiving the data on the present analysis of the effluent; determining whether a present level of at least one contaminant is within a predetermined range; and determining whether a present level of at least one corrosive is within another predetermined range.

In an alternate embodiment of the present invention, a system for detecting at least one contaminant on a component of a compressor, on a compressor, the system comprising: a turbomachine comprising: an air inlet system; a compressor; a turbine section; an offline water-wash system comprising at least one spray manifold, and a drainage system; wherein the offline water-wash system injects a cleaning fluid into a compressor of a turbomachine; and utilizes the drainage system to receive an effluent created by the offline water-wash system; wherein the effluent comprises the cleaning fluid; a device to analyze effluent within the drainage system; wherein the device generates data on a present analysis of the effluent; a control system comprising at least one processor, wherein the control system receives data on the present analysis of the effluent and performs at least one of the following the steps of: receives the data on the present analysis of the effluent; determines whether a present level of at least one containinant is within a predetermined range; and determines whether a present level of at least one corrosive is within another predetermined range.

### BRIEF DESCRIPTION OF THE DRAWINGS

These and other features, aspects, and advantages of the present invention will become better understood when the following detailed description is read with reference to the accompanying drawings in which like characters represent like elements throughout the drawings.

FIG. 1 is a schematic illustrating an environment where an embodiment of the present invention may operate.

FIG. 2 is a schematic illustrating an embodiment of the offline water-wash system of FIG. 1.

FIG. 3 is a flowchart illustrating a method of analyzing effluent of an offline water-wash system, in accordance with an embodiment of the present invention.

FIG. 4 is a block diagram of an exemplary system for analyzing effluent of an offline water-wash system in accordance with an embodiment of the present invention.

### DETAILED DESCRIPTION OF THE INVENTION

The following detailed description of preferred embodiments refers to the accompanying drawings, which illustrate specific embodiments of the invention. Other embodiments having different structures and operations do not depart from the scope of the present invention.

Certain terminology may be used herein for the convenience of the reader only and is not to be taken as a limitation on the scope of the invention. For example, words such as “upper”, “lower”, “left”, “right”, “front”, “rear”, “top”, “bottom”, “horizontal”, “vertical”, “upstream”, “downstream”, “fore”, “aft”, and the like; merely describe the configuration shown in the Figures. Indeed, the element or elements of an embodiment of the present invention may be oriented in any direction and the terminology, therefore, should be understood as encompassing such variations unless specified otherwise.

The present invention has the technical effect of analyzing, in or near real time, a sample of effluent exiting a compressor after an offline water-wash cycle. The results of the analysis may determine the level of fouling or level of corrosive deposits on the compressor. An embodiment of the present invention may allow for a control system to receive the analysis and determine whether an additional offline water-wash cycle should be performed to reduce the level of fouling or level of at least one corrosive deposits. An embodiment of the present invention may link the control system with a remote monitoring and diagnostics center for further review of the effluent and the compressor fouling. An embodiment of the present invention may link to a mitigation process, such as, but not limiting of, an on-line water wash system, if required.

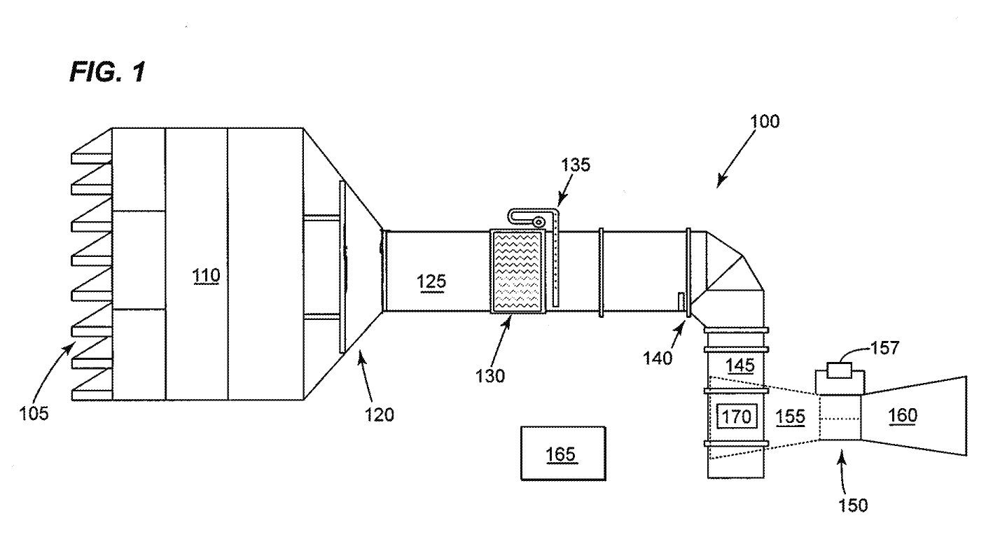

Referring now to the Figures, where the various numbers represent like elements throughout the several views, FIG. 1 is a schematic illustrating an environment where an embodiment of the present invention may operate. FIG. 1 illustrates an air inlet system 100 that may be integrated with a compressor 155 of a turbomachine 150. The following description provides an overview of one configuration of an air inlet system 100 and one configuration of a turbomachine 150. The present invention may be used with other configurations of the air inlet system 100 and/or turbomachine 150, which are not illustrated in the Figures.

The air inlet system 100 channels the airstream ingested by the compressor 155. The airstream usually derives from the local ambient environment in which the turbomachine 150 operates. Initially, the airstream flows around a weather hood 105, which may prevent weather elements, such as rain, snow, etc, from entering the compressor 155. The airstream may then flow through an inlet filter house 110; which generally removes foreign objects and debris from the airstream. Next, the airstream may flow through a transition piece 120 and an inlet duct 125; these components may adjust the velocity and pressure of the airstream. Next, the airstream may flow through a silencer section 130. Next, the airstream may flow through an inlet bleed heat system 135, which generally increases the airstream temperature prior to entering the compressor 155. A screen 140, or the like, may be located downstream of the inlet duct 125 and generally serves to prevent debris from entering the compressor 155. The inlet plenum 145 may connect the air inlet system 100 with the compressor 155 of the turbomachine 150.

The turbomachine 150 comprises a compressor 155 having a rotor. A control system 165 may control the operation of the turbomachine 150, which generally includes the following. An airstream deriving from the air inlet system 100 enters the compressor 155, is compressed and then discharges to a combustion system 157, where a fuel, such as a natural gas, is burned to provide high-energy combustion gases that drives the turbine section 160. In the turbine section 160, the energy of the hot gases is converted into work, some of which is used to drive the compressor 155.

During operation of the turbomachine 150, contaminants such as, but not limiting of, dust and corrosive elements within the airstream may foul the compressor 155. Fouling reduces the efficiency and output of the turbomachine 150. Periodically, operators may shutdown the turbomachine 150 to perform cleaning of the compressor 155 with an offline water-wash system 170. Typically, the offline water-wash system 170 injects de-min water and a detergent to remove the corrosives on the compressor 155. The effluent of an offline water-wash cycle exits the compressor 155. The control system 165 may control the operation of the offline water-wash system 170.

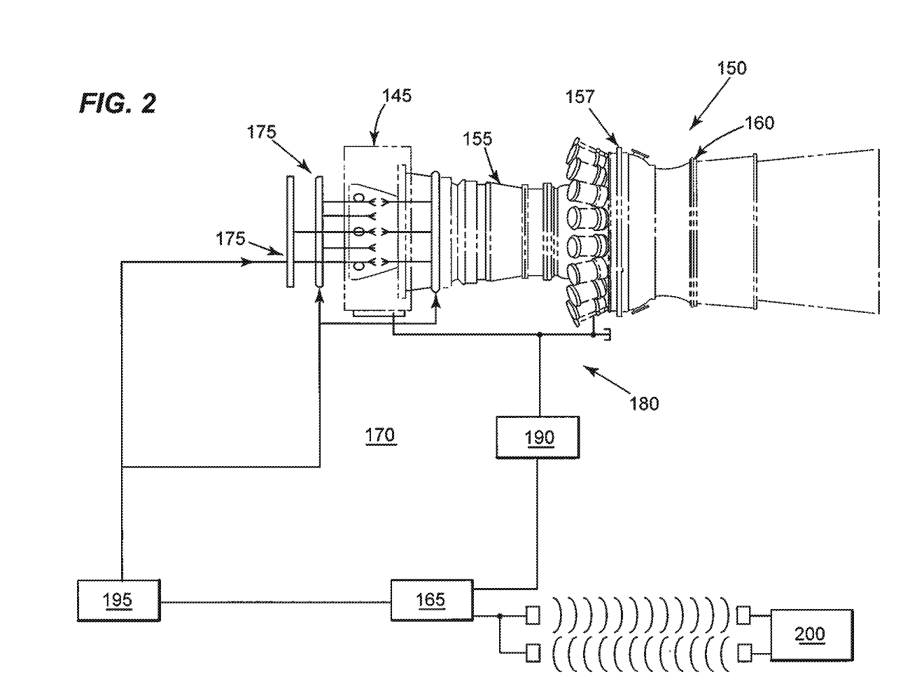

FIG. 2 is a schematic illustrating an embodiment of the offline water-wash system 170 of FIG. 1. An embodiment of the offline water-wash system 170 may comprise: a skid 195 connected to spray manifolds 175 and a device 190. A drainage system 180 moves the effluent away from the compressor 155.

The skid 195 may include a pump, tanks, and a controller integrated with the control system 165. The skid 195 delivers the fluid, such as, but not limiting of, de-min water, a detergent, or other mixtures thereof, to the spray manifolds 175; which then injects the fluid to the compressor 155. While flowing through the compressor 155, the fluid removes dirt and other corrosives, creating an effluent. The effluent flows through the drainage system 180. The device 190 may automatically receive and analyze a sample of the effluent on site.

The analysis results may be sent to the control system 165, which may determine whether at least one corrective action to reduce fouling and corrosion is required. The analysis results may also be used to build a historical database that includes water wash effectiveness, seasonal variation, and the like.

The corrective action may comprise a mitigation effort, which may include, but is not limited to. an additional offline water-wash cycle, an on-line water wash cycle, and the like. In an embodiment of the present invention, the analysis results may aid in determining whether components of the compressor 155 should be analyzed for potential corrosion issues that may lead to a component failure. The analysis results may also aid in determining whether a rotor (not illustrated) of the turbomachine 150, requires a repair. In an embodiment of the present invention, the level of deposits revealed in the analysis results may be classified into categories. Here, a specific mitigation effort may be developed for each category. For example, but not limiting of, data from the analysis results may be used to modify the on-fine water wash settings, when used for a mitigation result.

An embodiment of the present invention may utilize the analysis results to create or add to the historical database. The analysis results and the historical database may be used to adjust the parameters that control the on-line water wash system. For example, but not limiting of, if the analysis results indicate high levels of contaminants, then an embodiment of the present invention may seek to increase the on-line water wash frequency and/or duration to provide improved cleaning of the components of the compressor 155. However, if the offline water wash analysis indicates low levels of contaminants, then an embodiment of the present invention may seek to reduce the on-line water washing frequency and/or duration.

In an embodiment of the present invention the control system 165 may communicate with a remote system that may used the analysis results for other purposes. The remote system may have the form of a monitoring and diagnostics (RM&D) center 200. The RM&D center 200 may receive the analysis of the effluent and may perform further review, such as, but not limiting of, comparison with similarly configured turbomachines.

As will be appreciated, the present invention may be embodied as physical hardware, a method, system, or computer program product. Accordingly, the present invention may take the form of an entirely hardware embodiment, an entirely software embodiment (including firmware, resident software, micro-code. etc.) or an embodiment combining software and hardware aspects all generally referred to herein as a “circuit”, “module,” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic or optical storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in, but not limited to, an object oriented programming language such as Java7, Smalltalk or C++, or the like, including different versions of the aforementioned languages. However, the computer program code for carrying out operations of the present invention may also be written in conventional procedural programming languages, such as the “C” programming language, or a similar language. The program code may execute entirely on the user's computer, partly on the user's computer, as a stand-alone software package, partly on the user's computer and partly on a remote computer or entirely on a remote computer, or network of computers. In the latter scenario, the remote computer may be connected to the user's computer through, but not limited to, a local area network (LAN), a wide area network (WAN), a wireless network, and combinations thereof: or the connection may be made to an external computer (for example, through the Internet using an Internet Service Provider).

The present invention is described below with reference to flowchart illistrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The following detailed description of preferred embodiments refers to the accompanying drawings, which illustrate specific embodiments of the invention. Other embodiments having different structures and operations do not depart from the scope of the present invention.

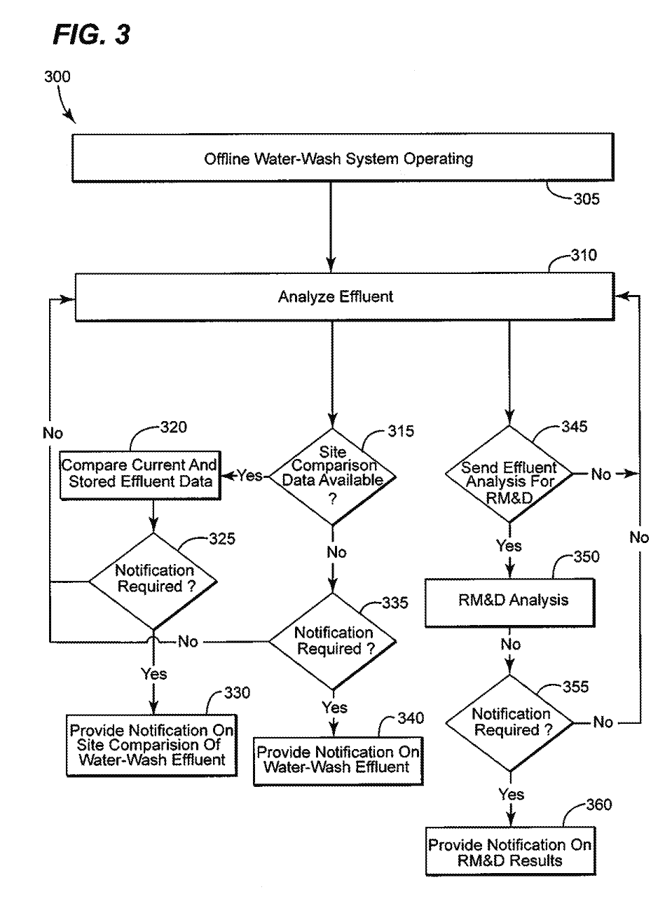

Referring now to FIG. 3 is a flowchart illustrating a method 300 of analyzing effluent created by an offline water-wash system 170, in accordance with an embodiment of the present invention. The method 300 may include at least one control system, which may function, for example, but not limiting of, in steps 305 to 360. In an embodiment of the present invention the method 300 may be integrated with a graphical user interface (GUI), or the like. The GUI may allow the operator to navigate through the method 300 described below. The GUI may also provide at least one notification of the status of the method 300.

In step 305, the offline water-wash system 170 may be operating. As discussed, the skid 195 may include a pump, a tank, and a controller integrated with the control system 165. The skid 195 delivers the cleaning fluid, such as, but not limiting of, de-min water, a detergent, or other mixtures thereof to the spray manifolds 175; which then injects the cleaning fluid to the compressor 155. While flowing through the compressor 155, the fluid removes dirt and other corrosives, creating an effluent. The eftluent flows through the drainage system 180. The device 190 may automatically receive and analyze a sample of the effluent.

Generally, if the operating environment of the turbomachine 150 is acidic in nature, then the corrosive deposits on the compressor 155 may be acidic in nature. These acidic corrosives may include for example, but not limiting of, sulfides, sulfates, or chlorides. The inlet filter house 110 may not completely mitigate the effect of these acidic corrosives on the compressor 155. The offline water-wash system 170 may mix at least one detergent with a cleaning fluid, creating a cleaning solution that may reduce the level of corrosive deposits on the compressor 155. Here, the cleaning solution may be considered mildly basic. The cleaning solution may react with the acidic deposits on the compressor 155, neutralizing, and possibly mitigating the corrosion. The pH range of the cleaning solution may be from about 7 to about 14. The detergent may include, but is not limited to at least one chemical agent of: sodium hydroxide; caustic soda; calcium hydroxide; ammonium hydroxide; ammonia water; magnesium hydroxide; a bleach; or combinations thereof.

Similarly, if the operating environment of the turbomachine 150 is caustic in nature, then the deposits on the compressor 155 may be caustic in nature. The inlet filter house 110 may not completely mitigate the effect of these caustic compounds on the compressor 155. The offline water-wash system 170 may mix at least one detergent with a cleaning fluid, creating a cleaning solution for reducing the amount of caustic deposits on the compressor 155. Here, the cleaning solution may be considered mildly acidic. The cleaning solution may react with the basic deposits on the compressor 155, neutralizing, and possibly mitigating the corrosion. The pH range of the cleaning solution may be from about 1 to about 7. The detergent may include, but is not limited to at least one chemical agent of: hydrochloric acid; sulfuric acid; nitric acid; carbonic acid; uric acid; ascorbic acid; citric acid; acetic acid; tannic acid; tartaric acid; or the like.

In step 310, the method 300 may analyze the effluent flowing through the drainage system 180 using the device 190. Generally, the device 190 receives a sample of the effluent flowing in the drainage system 180. The device 190 may comprise at least one particulate analyzer, or the like, which may separate at least one corrosive from the effluent sample. The device 190 may also comprise at least one device for determining the pH of the effluent sample. The device 190 may also comprise a device for determine the conductivity of the effluent sample. The device 190 may also comprise a device for determining at least one chemical element constituent measurement. The device 190 may also determine the size and number of particles and or particulate within the effluent sample. For example, but not limiting of, the device 190 may be in the form of a particulate analyzer, pH monitor, a conductivity reading device, chemical element constituent or combinations thereof.

The method 300 may utilize the pH since the pH may give a reasonable indication of the level of corrosive(s) on the compressor 155. Also, the method 300 may utilize the processing unit to separate at least one corrosive from the effluent sample, because the corrosive may be in a liquid form and/or a condensable vapor within the effluent. Generally, an operating compressor 155 causes a temperature depression and negative pressure of the ingested airstream. The operation of the compressor 155 may cause the condensable vapors and/or liquids to deposit on the components, such as, but not limiting of, the blades of the compressor 155. For example, but not limiting of, sulfides, sulfates, or chlorides may exist within the airstream entering the compressor 155. The condensation and temperature depression in the airstream, due to the operation of the compressor 155, may cause the condensate to fall onto the stages of the compressor 155. This action allows for the sulfides, sulfates or chlorides, etc to dissolve in the condensing water allowing for an acid to form and deposit onto the compressor 155 blades. An offline water-wash cycle may remove the corrosive deposit(s) from components of the compressor 155. These corrosive deposits may become part of the effluent. The effluent sample may then be analyzed by a particulate analyzer of the at least one device 190, to determine the type of corrosive deposits that may have existed on the components of the compressor 155. Also, the method 300 may utilize the conductivity reading to independently determine a pH value derived from the effluent sample.

Referring again to FIG. 3, in an embodiment of the present invention the method 300 may concurrently perform more than one series of instructions. In steps 315-340, the method 300 utilizes the results of step 310 to perform an onsite determination of the level of fouling of the compressor 155, as further described below. In steps 345-360, the method 300 may send the results of step 310 to a remote monitoring and diagnostics center 200, for a remote determination and storing of the level of fouling and the level of corrosion of the compressor 155, as further described below.

In step 315 the method 300 may determine whether site comparison date is available. Here, the method 300 may communicate with a storage system, or the like (not illustrated in the Figures) to determine whether data from a previous analysis or analyses of the effluent sample performed in step 310 was stored. This data may be compared with results from the most recent analysis. If data from previous at least one analysis is available, then the method 300 may proceed to step 320: otherwise the method 300) may proceed to step 335.

In step 320, the method 300 may compare the current analysis of the effluent sample with at least one stored analysis of the same. Here, for example, but not limiting of, the method 300 may trend the results to determine if the level, rate, or severity of fouling is increasing or decreasing.

In step 325, the method 300 may determine whether a notification is required. In an embodiment of the present invention the method 300 may include a parameter that may have the form of, for example, but not limiting of, a rage, a limit, or the like. The parameter may comprises at least one of the following: an allowable level of at least one chemical element in the effluent; an allowable level of the at least one corrosive in the effluent: an allowable pH level, an allowable conductivity level; an allowable particle distribution of at least one particle within the effluent, an allowable difference between the current analysis and the analysis or analyses being compared, or combinations thereof. For example, but not limiting of, if the current level of pH differs by around 10% from a previous stored pH level, then a notification of this difference may be required. If a notification is required, then the method 300 may proceed to step 330, otherwise, the method 300 may revert to step 310.

In step 330, the method 300 may provide a notification of the results of the on-site comparison of the water-wash effluent. The notification may be sent to the control system 165. The notification may be in the form of an alarm, and/or other message providing the results of the comparison. The notification may also indicate whether a corrective action, as previously described, is recommended.

Referring now to step 335, where the method 300 may determine whether a notification is required when site comparison data is not available. In an embodiment of the present invention the method 300 may include a parameter that may have the form of, a range, a limit, or the like. The parameter may comprise at least one of the following: an allowable level of at least one chemical element in the effluent; an allowable level of the at least one corrosive in the effluent; an allowable pH level, an allowable conductivity level; an allowable particle distribution of at least one particle within the effluent. For example, but not limiting of, if the current level of pH differs by around 10% from a previous stored pH level, then a notification of this difference may be required. If a notification is required then the method 300 may proceed to step 340, otherwise, the method 300 may revert to step 310.

In step 340, the method 300 may provide a notification on the results of the analysis of the effluent sample, performed in step 310. The notification may be sent to the control system 165. The notification may be in the form of an alarm, and/or other message providing the results of the analysis. The notification may also indicate whether a mitigation action, as previously described is recommended.

Referring now to step 345, where the method 300 may determine whether to send the results of the analysis of the effluent sample, performed in step 310 to at least one remote analysis center such as a RM&D center 200. Here, for example, but not limiting of, an operator of the turbomachine 150 may desire to have the results of the analysis compared with at least one other turbomachine that is similarly configured and operates in a similar ambient environment. If the analysis is to be sent to the remote monitoring and diagnostics center 200, then the method 300 the method 300 may proceed to step 350, otherwise the method 300 may revert to step 310.

In step 350, the remote monitoring and diagnostics (RM&D) center 200 may perform an independent analysis on the results of the effluent analysis performed, for example, but not limiting of, in step 310. In an embodiment of the present invention, the RM&D center 200 may compare the results of the effluent analysis with at least one other turbomachine. In another embodiment of the present invention, the analysis results may be used to create and/or modifying a fleet wide baseline on the fouling of similar compressors operating under similar ambient condition.

In step 355, the method 300 may determine whether a notification from the RM&D center 200 should be sent to an operator of the turbomachine 150. In an embodiment of the present invention, the RM&D center 200 may use at least one parameter in the form of, for example, but not limiting of, a range, a limit, or the like. The parameter may comprises at least one of the following: an allowable pH level based on fleet wide data, an allowable percentage of the at least one particulate within the effluent sample based on fleet wide data, an allowable conductivity range based on fleet wide data, an allowable difference between the current analysis and the analysis or analyses being compared, or combinations thereof. For example, but not limiting of, if the current level of pH differs by around 10% from a previous stored pH level, then a notification of this difference may be required. If a notification is required then the method 300 may proceed to step 360, otherwise, the method 300 may revert to step 310.

In step 360, the method 300 may provide a notification of the results of the RM&D center 200 analysis. This notification may be received by the control system 165. The notification may be in the form of an alarm, report, and/or other message providing the results of the comparison. The notification may also indicate whether a corrective action, as previously described, is recommended.

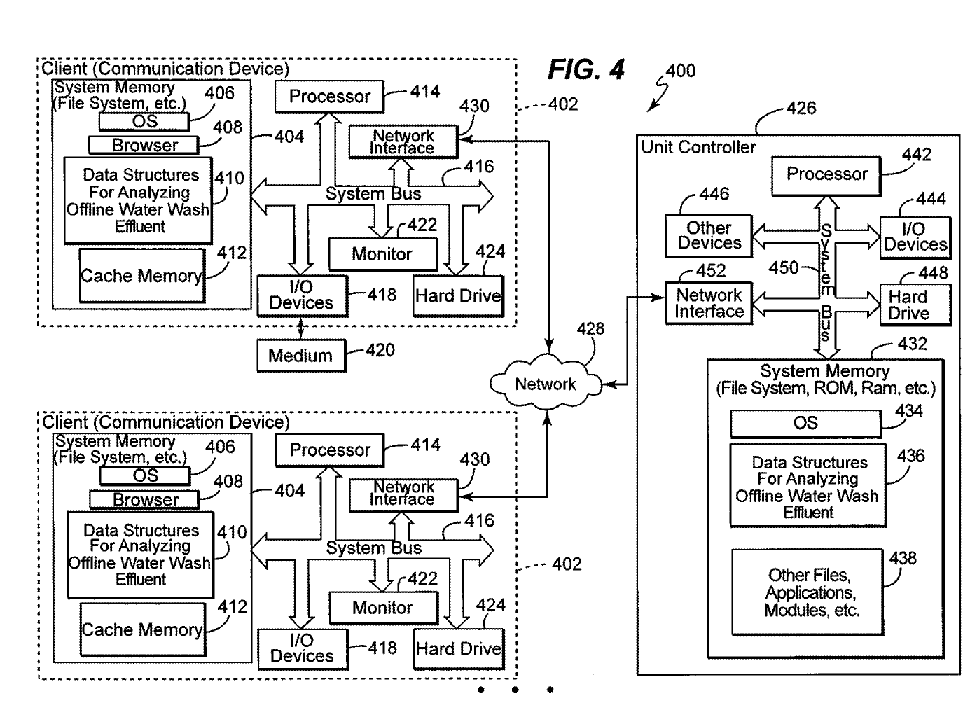

FIG. 4 is a block diagram of an exemplary system 400 for analyzing the effluent created during an offline water-wash, in accordance with an embodiment of the present. The elements of the method 300 may be embodied in and performed by the system 400. The system 400 may include one or more user or client communication devices 402 or similar systems or devices (two are illustrated in FIG. 4). Each communication device 402 may be for example, but not limited to, a computer system, a personal digital assistant, a cellular phone, or similar device capable of sending and receiving an electronic message.

The communication device 402 may include a system memory 404 or local file system. The system memory 404 may include for example, but is not limited to, a read only memory (ROM), a random access memory (RAM), a flash memory, and other storage devices. The ROM may include a basic input/output system (BIOS). The BIOS may contain basic routines that help to transfer information between elements or components of the communication device 402. The system memory 404 may contain an operating system 406 to control overall operation of the communication device 402. The system memory 404 may also include a browser 408 or web browser. The system memory 404 may also include data structures 410 or computer-executable code for analyzing the effluent created during an offline water-wash in accordance with an embodiment of the present invention that may be similar or include elements of the method 300 in FIG. 3. The system memory 404 may further include a template cache memory 412, which may be used in conjunction with the method 300 in FIG. 3 for analyzing the effluent created during an offline water-wash.

The communication device 402 may also include a processor or processing unit 414 to control operations of the other components of the communication device 402. The operating system 406, browser 408, and data structures 410 may be operable on the processing unit 414. The processing unit 414 may be coupled to the memory system 404 and other components of the communication device 402 by a system bus 416.

The communication device 402 may also include multiple input devices (I/O), output devices or combination input/output devices 418. Each input/output device 418 may be coupled to the system bus 416 by an input/output interface (not shown in FIG. 4). The input and output devices or combination I/O devices 418 permit a user to operate and interface with the communication device 402 and to control operation of the browser 408 and data structures 410 to access, operate and control the software for analyzing the effluent created during an offline water-wash. The I/O devices 418 may include a keyboard and computer pointing device or the like to perform the operations discussed herein.

The I/O devices 418 may also include for example, but are not limited to, disk drives, optical, mechanical, magnetic, or infrared input/output devices, modems or the like. The I/O devices 418 may be used to access a storage medium 420. The medium 420 may contain, store, communicate, or transport computer-readable or computer-executable instructions or other information for use by or in connection with a system, such as the communication devices 402.

The communication device 402 may also include or be connected to other devices, such as a display or monitor 422. The monitor 422 may permit the user to interface with the communication device 402.

The communication device 402 may also include a hard drive 424. The hard drive 423 may be coupled to the system bus 416 by a hard drive interface (not shown in FIG. 4). The hard drive 424 may also form part of the local file system or system memory 404. Programs, software, and data may be transferred and exchanged between the system memory 404 and the hard drive 424 for operation of the communication device 402.

The communication device 402 may communicate with at least one unit controller 426 and may access other servers or other communication devices similar to communication device 402 via a network 428. The system bus 416 may be coupled to the network 428 by a network interface 430. The network interface 430 may be a modem. Ethernet card, router, gateway, or the like for coupling to the network 428. The coupling may be a wired or wireless connection. The network 428 may be the Internet, private network, an intranet, or the like.

The at least one unit controller 426 may also include a system memory 432 that may include a file system, ROM, RAM, and the like. The system memory 432 may include an operating system 434 similar to operating system 406 in communication devices 402. The system memory 432 may also include data structures 436 for monitoring the corrosives of an airstream. The data structures 436 may include operations similar to those described with respect to the method 300 for analyzing the effluent created during an offline water-wash. The server system memory 432 may also include other files 438, applications, modules, and the like.

The at least one unit controller 426 may also include a processor 442 or a processing unit to control operation of other devices in the at least one unit controller 426. The at least one unit controller 426 may also include I/O device 444. The I/O devices 444 may be similar to I/O devices 418 of communication devices 402. The at least one unit controller 426 may further include other devices 446, such as a monitor or the like to provide an interface along with the I/O devices 444 to the at least one unit controller 426. The at least one unit controller 426 may also include a hard disk drive 448. A system bus 450 may connect the different components of the at least one unit controller 426. A network interface 452 may couple the at least one unit controller 426 to the network 428 via the system bus 450.

The flowcharts and step diagrams in the figures illustrate the architecture, functionality, and operation of possible implementations of systems, methods, and computer program products according to various embodiments of the present invention. In this regard, each step in the flowchart or step diagrams may represent a module, segment, or portion of code, which comprises one or more executable instructions for implementing the specified logical function(s). It should also be noted that, in some alternative implementations, the functions noted in the step may occur out of the order noted in the figures. For example, two steps shown in succession may, in fact, be executed substantially concurrently, or the steps may sometimes be executed in the reverse order, depending upon the functionality involved. It will also be noted that each step of the step diagrams and/or flowchart illustration, and combinations of steps in the step diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers. steps, operations, elements, components, and/or groups thereof.

Although the present invention has been shown and described in considerable detail with respect to only a few exemplary embodiments thereof, it should be understood by those skilled in the art that we do not intend to limit the invention to the embodiments since various modifications, omissions and additions may be made to the disclosed embodiments without materially departing from the novel teachings and advantages of the invention, particularly in light of the foregoing teachings. Accordingly, we intend to cover all such modifications, omission, additions and equivalents as may be included within the spirit and scope of the invention as defined by the following claims.

What is claimed is:

1. A method of detecting at least one contaminant on a component of a compressor, the method comprising:
providing an offline water-wash system comprising a drainage system;
wherein the offline water-wash system performs the steps of:
injecting a cleaning fluid into a compressor of a turbomachine: and
utilizing the drainage system to receive an effluent created by the offline water-wash system; wherein the effluent comprises the cleaning fluid;
utilizing a device to analyze the effluent, wherein the device generates data on a present analysis of the effluent; and
providing a control system, wherein the control system performs at least one of the following the steps of:
receiving the data on the present analysis of the effluent;
determining whether a present level of at least one contaminant is within a predetermined range; and
determining whether a present level of at least one corrosive is within another predetermined range.

2. The method of claim 1, further comprising providing a notification if the analysis of the effluent determines that the present level of the at least one contaminant is not within the predetermined range.

3. The method of claim 1, further comprising:
receiving data on a previously stored analysis of effluent created during a previous operation of the offline water-wash system; and
comparing the data on the previously stored analysis of effluent with the data on the present analysis of effluent.

4. The method of claim 1, further comprising determining whether to communicate results from the device to a remote system, wherein the device is physically located at a first location and the remote system is physically located at a second location.

5. The method of claim 4, wherein the remote system compares the data on the present analysis of effluent with data on a stored analysis of effluent.

6. The method of claim 1, wherein the device determines at least one of:
a level of at least one chemical element in the effluent;
a level of the at least one corrosive in the effluent:
a pH value of the effluent;
a conductivity level of the effluent, or
a particle distribution of at least one particle within the effluent.

7. The method of claim 6, wherein the control system performs at least one of the following steps:
determining whether the level of the at least one chemical element is within a mass range:
determining whether the level of the at least one corrosive is within a corrosive range;
determining whether the pH value is within a pH range;
determining whether the conductivity level is within a conductivity range; or
determining whether the particle distribution is within a distribution range.

8. The method of claim 7, wherein the control system performs at least of the following steps:
comparing a previously stored level of the at least one chemical element with a present level of the at least one chemical element;
comparing a previously stored level of the at least one corrosive with a present level of the at least one corrosive;
comparing a previously stored pH value with a present pH value; or
comparing a previously stored conductivity level with a present conductivity level; or
comparing a previously stored particle distribution with a present particle distribution.

9. The method of claim 7, further comprising at least one of:
storing the level of the at least one chemical element;
storing the level of the at least one corrosive;
storing the pH value;
storing the conductivity level; or
storing the particle distribution.

10. The method of claim 8, further comprising operating the offline water-wash system if at least one of the following occurs:
the level of the at least one chemical element is not within the mass range;
the level of the at least one corrosive is not within the corrosive range;
the pH value is not within the pH range; or
the conductivity level is not within the conductivity range, or
the particle distribution is not within the particle distribution range.

11. A system for detecting at least one contaminant on a component of a compressor, on a compressor, the system comprising:
a turbomachine comprising:
an air inlet system;
a compressor;
a turbine section;
an offline water-wash system comprising at least one spray manifold, and a drainage system; wherein the offline water-wash system injects a cleaning fluid into a compressor of a turbomachine; and utilizes the drainage system to receive an effluent created by the offline water-wash system; wherein the effluent comprises the cleaning fluid;
a device to analyze effluent within the drainage system; wherein the device generates data on a present analysis of the effluent;
a control system comprising at least one processor, wherein the control system receives data on the present analysis of the effluent and performs at least one of the following the steps of:
receives the data on the present analysis of the effluent;
determines whether a present level of at least one contaminant is within a predetermined range; and
determines whether a present level of at least one corrosive is within another predetermined range.

12. The system of claim 11, wherein the at least one processor:
receives data on a previously stored analysis of effluent created during a previous operation of the offline water-wash system; and
compares the data on the previously stored analysis of effluent with the data on the present analysis of effluent.

13. The system of claim 11, wherein the control system determines whether to communicate results from the device to a remote system, wherein the device is physically located at a first location and the remote system is physically located at a second location transmit results from the device to a remote system.

14. The system of claim 13, wherein the remote system comprises at least one computer system, wherein the at least one computer system compares data on the present analysis of effluent with data on a stored analysis of effluent.

15. The system of claim 11, wherein the device determines at least one of:
a level of at least one chemical element in the effluent;
a level of at least one corrosive in the effluent;
a pH value of the effluent;
a conductivity level of the effluent; or
a particle distribution in the effluent.

16. The system of claim 11, wherein the at least one processor performs at least of the following steps:
determines whether the level of the at least one chemical element is within a mass range;
determines whether the level of the at least one corrosive is within a corrosive range;
determines whether the pH value is within a pH range;
determines whether the conductivity level is within a conductivity range; or
determines whether the particle distribution is within a particle distribution range.

17. The system of claim 16, wherein the at least one processor performs at least of the following steps:
compares a previously stored level of the at least one chemical element with a current level of the at least one chemical element;
compares a previously stored level of the at least one corrosive with a present level of the at least one corrosive;
compares a previously stored pH value with a current pH value;
compares a previously stored conductivity level with a current conductivity level; or
compares a previously stored particle distribution with a current particle distribution.

18. The system of claim 17, wherein the at least one processor performs at least one of the following steps:
stores the level of the at least one chemical element;
stores the level of the at least one corrosive;
stores the pH value;
stores the conductivity level; or
stores the particle distribution.

19. The system of claim 18, wherein the control system controls the offline water-wash system, and operates the offline water-wash system if at least one of the following occurs:
the level of the at least one chemical elements is not within the chemical element range;
the level of the at least one corrosive is not within the corrosive range;
the pH value is not within the pH range;
the conductivity level is not within the conductivity range; or
the particle distribution is not within the particle distribution range.

20. The system of claim 11, wherein the device is located within the drainage system.

21. The system of claim 18, wherein the control system initiates at least one mitigation action if at least one of the following occurs:
the level of the at least one chemical element is not within the chemical element range;
the level of the at least one corrosive is not within the corrosive range;
the pH value is not within the pH range;
the conductivity level is not within the conductivity range; or
the particle distribution is not within the particle distribution range.

22. The system of claim 21, wherein the mitigation action comprises operation of the offline water-wash system.
